(19) United States
(12) Patent Application Publication
(10) Pub. No.: US 2009/0116968 A1
(43) Pub. Date: May 7, 2009

(54) Blade for wind turbines & an improved wind turbine

(76) Inventor: Robert E. Mohle, Villa Park, CA (US)

Correspondence Address: LAW OFFICES OF ANDREW SCHROEDER, P.O. Box 6731, Santa Maria, CA, 93454, US

(21) Appl. No.: 11/982,626

(22) Filed: Nov. 5, 2007

(51) Int. Cl. F01D 5/14; F03D 11/00; F03D 9/00

(52) U.S. Cl. 416/241 R; 416/223 R; 290/55

(57) ABSTRACT

An improved blade for a wind turbine incorporates a planar member. The planar member has a leading surface, a trailing surface, an inboard side, an outboard side, an inner impulse surface, an outer impulse surface. The inner impulse surface and outer impulse surface are used for the purpose of actuating the wind turbine from a state of rest and for the purpose of imparting turbulence. By producing a breakdown in the laminar flow between the impulse surface and the trailing surface the improved blade will rotate slower thereby decreasing the amount of wear and tear to the wind turbine.

### FIELD OF INVENTION

The present invention relates with environmentally friendly and sustainable energy, and more particularly relates with improved wind turbines.

### BACKGROUND OF INVENTION

One of the overarching issues facing industrialized nations today is generating energy and power to meet all our needs efficiently without generating greenhouse gases. Many smokestack industries have been able to generate energy using relatively cost-effective means. However, these same industries also release so many greenhouse gases and other pollutants, many scientists are convinced that their entry into the Earth's atmosphere is contributing to the global warming effect. As a result of the substantial burden to Earth's atmosphere scientists predict dire consequences in climate changes throughout the world such as increased hurricanes, droughts, famines, and flooding.

To combat this trend many industries have turned to alternative fuels and other means of generating electricity. Although a substantial amount of progress has been made many of these technologies are still in their infancy and need more research and development in order to fully realize their potential.

One method of producing energy is through capturing the kinetic energy in wind. This method dates back for centuries. By harnessing the wind to turn blades which in turn spins a rotor electricity may be produced. The use of wind power is very attractive and has many appealing benefits.

One benefit which inheres with the use of harnessing wind power is the fact that it is largely sustainable and renewable. In many parts of the world there is a constant stream of wind, which has seemingly infinite amounts of kinetic energy.

In the United States, harnessing wind power is becoming increasingly more feasible. The “payback time” of a large wind turbine (the time it takes to make up for its cost through accrued savings) is between three to eight years. In addition, over the past 20 years the cost per kilowatt hour has plummeted from 30 cents per kwh to 3-5 cents per kwh. By comparison, harnessing electricity from coal is between 4-5 cents per kwh including amortization of construction costs. For these reasons, the US Department of Energy estimates that wind power has the potential to supply 20% of the electricity needs of the United States.

One way of making wind power more feasible is through reducing maintenance costs and through increasing the life span of wind turbines. Currently, many wind turbines require around 10% of its purchase price in maintenance costs every five years.

Due to the high stress of the wind on the blades, rotors, and attendant components, some wind turbines are not as economically feasible as they could be. Many wind turbines are equipped with various braking systems to shut down the wind turbines after wind speeds pass a pre-determined threshold. During this period of high wind speeds, the wind turbine is not generating electricity and thereby reduces its efficiency.

Another way of increasing the economic justification for wind turbines is by limiting the number of components which are used in most wind turbines. Some components such as the starter may be optional in some instances. Fewer components mean less maintenance by the end user, as well as less cost to the OEM (original equipment manufacturer).

Therefore, what are clearly needed in the marketplace is an apparatus which can increase the lifespan of a wind turbine thereby making it more economically feasible.

### SUMMARY OF THE INVENTION

It is an object of the present invention to provide an apparatus, which will eliminate the need for a starter in wind turbines. The improved blade will obviate the need for a starter with impulse surfaces, which will actuate the blades from a resting position.

It is an object of the present invention to provide an improved blade, which will slow the blade down during higher wind speeds. By slowing the rotational speed of the blades, less wear and tear will be incurred to the blades.

Moreover, by slowing the blades down, the wind turbines will be able to operate in higher wind speeds thus making it operable for longer periods of time.

### BRIEF DESCRIPTION OF DRAWING FIGURES

FIG. 1 is a plan view of a preferred embodiment of the present invention.

FIG. 1b is a perspective view of a preferred embodiment of the present invention.

FIG. 1c is a side view of a preferred embodiment of the present invention.

FIG. 1d is a plan view of a preferred embodiment of the present invention.

FIG. 1e is a plan view of a preferred embodiment of the present invention.

FIG. 1f is a plan view of a preferred embodiment of the present invention.

FIG. 2 is a side view of a preferred embodiment of the present invention.

FIG. 3 is a plan view of a preferred embodiment of the present invention.

FIG. 4 is a plan view of a preferred embodiment of the present invention.

FIG. 5 is a plan view of a preferred embodiment of the present invention.

FIG. 6 is a plan view of a preferred embodiment of the present invention.

FIG. 7 is a plan view of a preferred embodiment of the present invention.

FIG. 8 is a plan view of a preferred embodiment of the present invention.

FIG. 9 is a plan view of a preferred embodiment of the present invention.

FIG. 10 is a plan view of a preferred embodiment of the present invention.

### DESCRIPTION OF PREFERRED EMBODIMENTS

According to a preferred embodiment of the present invention, a unique system, and apparatus are used to provide for a starter-less wind turbine. Moreover, the present invention substantially increases the financial justification of wind turbines as a viable renewable energy source by vastly improving the lifespan of various wind turbines. The present invention drastically decreases the need for maintenance servicing and repairs.

For the purposes of the present invention the term “wind turbine” shall encompass any type of wind turbines known in the art. Examples include, but are not limited to the following: vertical & wind turbines (hereafter “VAWT's”), horizontal & wind turbines hereafter (hereafter “HAWT's), Darrieus-type wind turbines, Darrieus-hybrid wind turbines, etc. Although various terms and names regarding various wind turbines are used, unless otherwise noted, the term “wind turbine” should be used in its broadest scope.

For the purposes of the present invention the term “pultrusion” shall generally refer to the continuous process of manufacturing of composite materials with constant cross-section whereby reinforcing fibers are pulled through a resin, possibly followed by a separate pre-forming system, and into a heated die, where the resin undergoes polymerization.

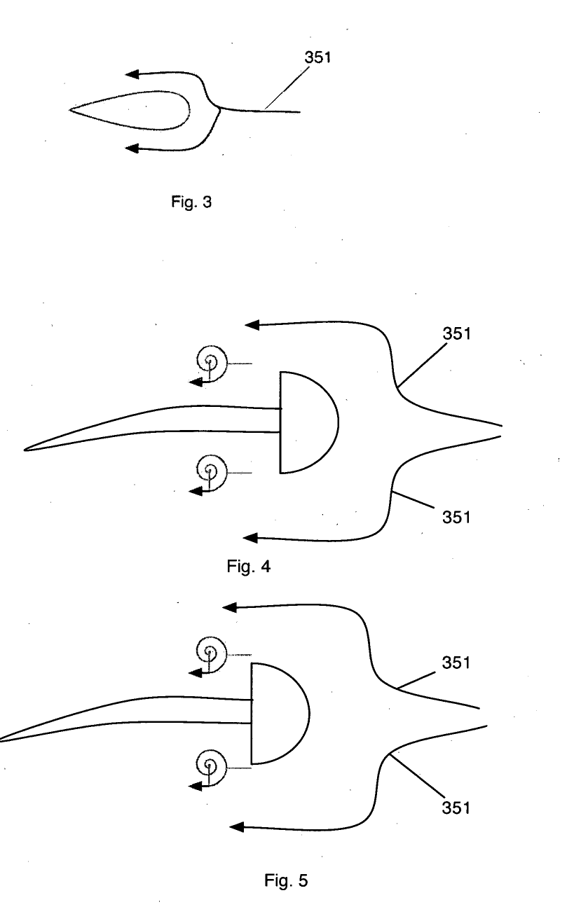

For the purposes of the present invention the term “laminar flow” describes the phenomenon where a fluid (i.e. air) flows in parallel layers with no disruption between the layers. This is illustrated in FIGS. 3-5.

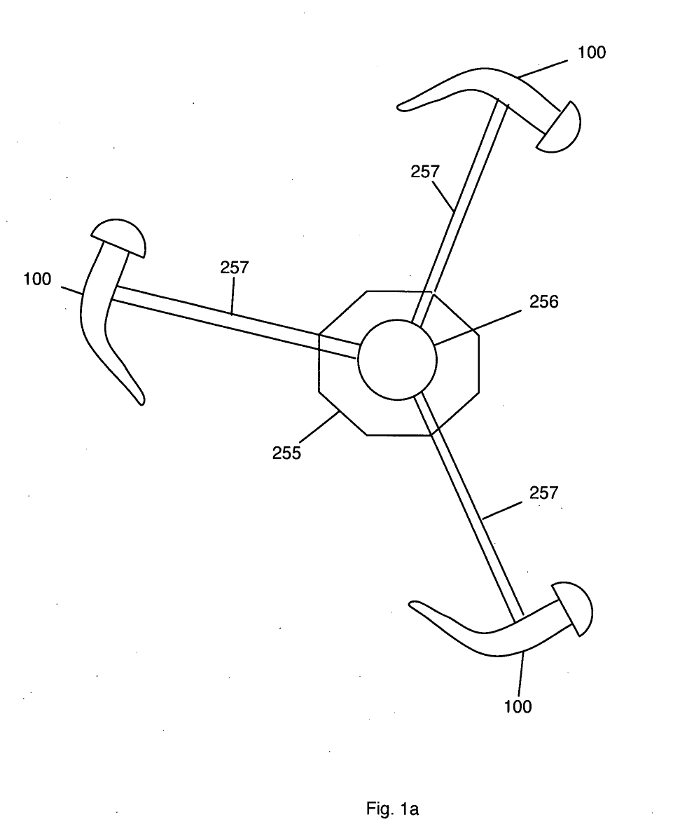

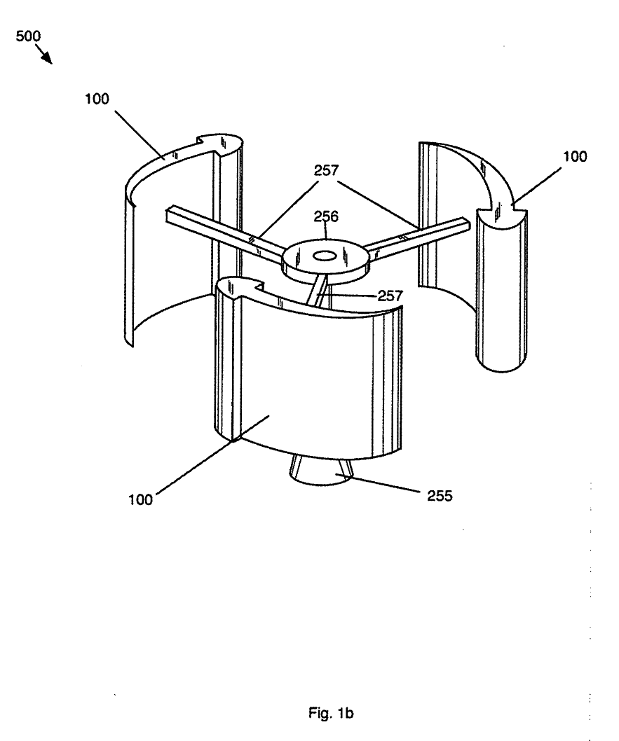

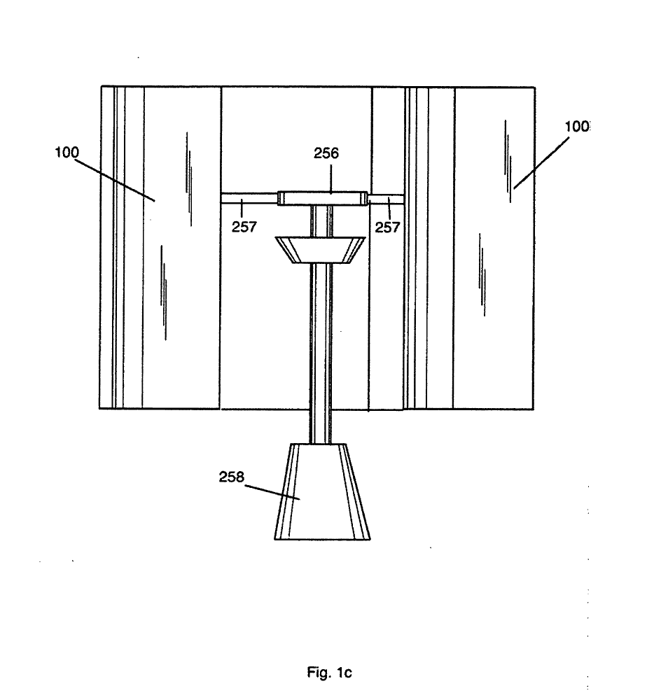

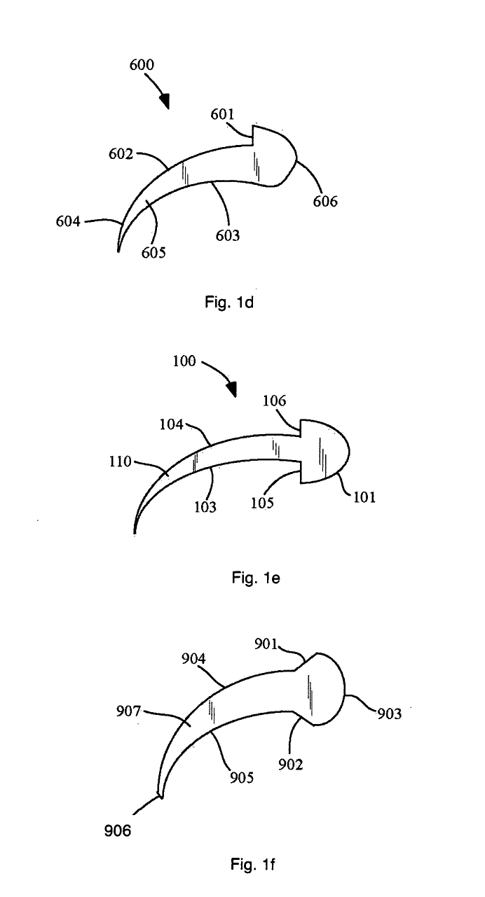

FIG. 1e illustrates a preferred embodiment of the present invention. It is worth noting here that FIG. 1e is a plan view as are FIGS. 1d and 1f. An improved blade 100 for use in wind turbines includes a planar member 10 comprising a leading surface 101, a trailing surface 102, an inboard side 103, an outboard side 104, an inner impulse surface 105, and an outer impulse surface 106. In some preferred embodiments the outboard side is longer than the inboard side.

FIGS. 1a and 1b also show the improved blade 100 in operation. An improved VAWT 500 includes at least one improved blade 100, at least one arm 257, a mast 258, at least one generator 255, and a spindle 256. The improved blade is connected with the arm. The arm is connected with the spindle.

It should be noted here that the present invention is not intended to be limited in its scope with respect to only producing electricity. Other preferred embodiments may be used for the purpose of powering a water pump, gears, machines, or engines. For this reason, not every improved VAWT or HAWT of wind turbines will be accompanied with a generator.

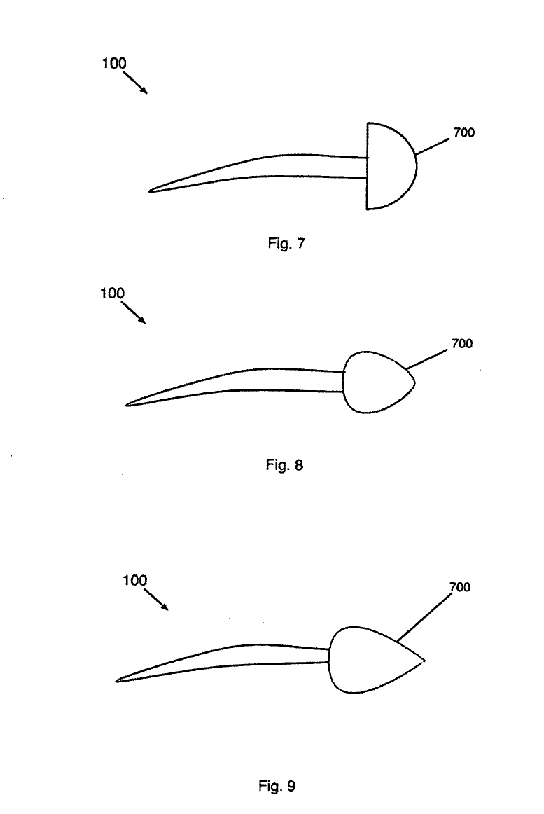

FIGS. 7-9 illustrate that the present invention can incorporate a variety of different shapes with respect to the leading surface. In FIG. 7 the leading surface has a rounded shape. In FIG. 8, the leading surface has an elliptical shape. And in FIG. 9, the leading surface has a pointed shape. The type of shape of the leading surface will depend upon a panoply of factors such as wind direction, climate, and tower height.

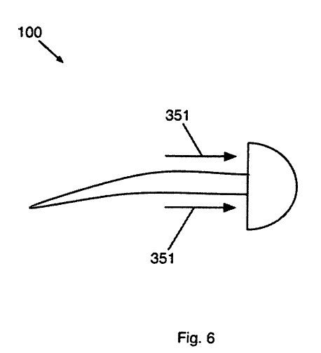

FIG. 6 illustrates how the inner impulse surface and outer impulse surface are used for the purpose of actuating the wind turbine from a state of rest. Wind 351 flows towards the impulse surfaces. The resulting force propels the blade from a state of rest. In other words, by actuating the wind turbine through the use of wind, rather than a built-in starter, the wind turbine will not require a starter. As a result, the resulting wind turbine will be less expensive to produce and manufacture. In addition, with fewer moving parts in the wind turbine, less maintenance issues will result from the absence of a starter.

As illustrated in FIGS. 3-5 the impulse surfaces are also utilized for the purpose of imparting turbulence and producing a breakdown in the laminar flow between the impulse surface and the trailing surface. By producing this breakdown of the laminar flow, the improved blades will actually move slower due to its less-aerodynamic shape or profile. This slowing of the blades will act to extend the life of the blade as well as the wind turbine itself. It should be noted here that the rounded blade mentioned below and illustrated in FIG. 1f produces more turbulence because of its rounded shape.

FIG. 1d illustrates that in some preferred embodiments the improved blade may incorporate only one surface for the purpose of actuating the improved blade. The one-sided blade 600 incorporates a first surface 606, an actuating surface 601, a second surface 602, a rear surface 604, and a third surface 603. FIG. 1f and FIG. 5 illustrate another improved blade with rounded actuating surfaces. The rounded blade 900 incorporates a front surface 903, a first rounded propelling surface 901, a second rounded propelling surface 902, a first surface 904, a second surface 905, and a back end 906.

The rounded blade may be more expedient in climates where there are moderate winds. The rounded blades may create less turbulence Thereby speeding up the blades. Moreover, since these blades are expected to be used in stronger wind climates, the rounded propelling surfaces do not require as much actuating force from the winds.

In addition, it is possible that the type of blade whether they are rounded, one-sided, or straight may vary by season as wind speeds may fluctuate in periods of storms, etc. For instance, in climates where strong winds are occasioned, a lower impulse angle may be used because less force will be needed to actuate the blade.

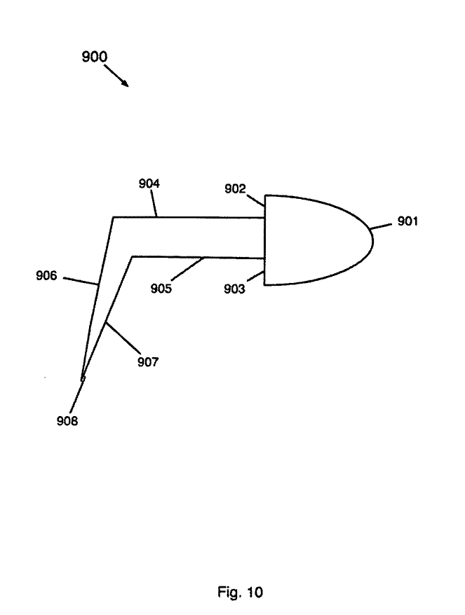

FIG. 10 illustrates another preferred embodiment of an improved blade. The Bent Blade 900 incorporates a forward side 901, a first impelling side 902, a second impelling side 903, a first plane 904, a second plane 905, a third plane 906, a fourth plane 907, and an end 908.

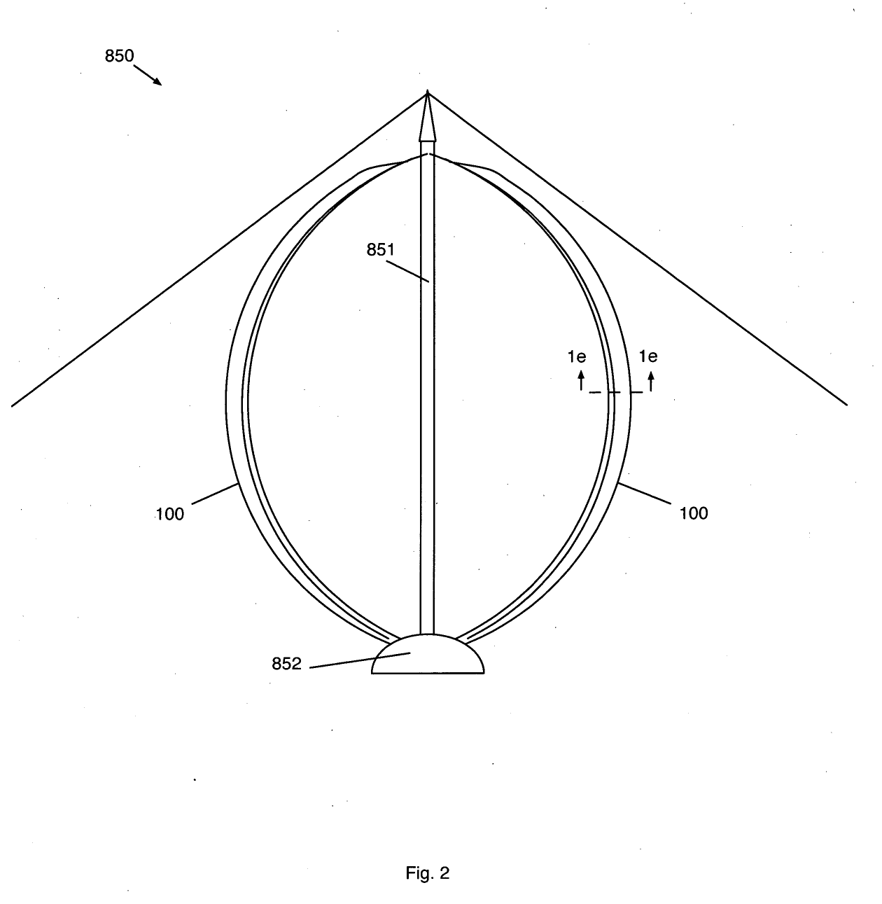

FIG. 2 illustrates an improved Darrieus-type wind turbine 850. The improved Darrieus turbine incorporates at least one improved blade 100, an apparatus for producing electricity 852 and a pole 851. It should be pointed out here that the improved blade may embody the various improved blades described above.

Those skilled in the art will appreciate numerous variations in the present system, configuration and operation that are within the scope of the invention.

Those skilled in the art will also appreciate how the principles illustrated in these preferred embodiments can be used in other examples of the invention. A particular reference number in one figure refers to the same element in all of the other figures.

Moreover, it will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. An improved blade for use in wind turbines comprising:
a planar member comprising a leading surface, a trailing surface, an inboard side, an outboard side, an inner impulse surface, an outer impulse surface, the inner impulse surface and outer impulse surface are used for the purpose of actuating the wind turbine from a state of rest and for the purpose of imparting turbulence and producing a breakdown in the laminar flow between the impulse surface and the trailing surface.

2. The improved blade of claim 1 wherein the outboard side is longer than the inboard side.

3. The improved blade of claim 1 wherein the improved blade is comprised of a fiber-reinforced resin composite structure.

4. The improved blade of claim 1 wherein the improved blade is comprised of carbon fiber.

5. The improved blade of claim 1 wherein the leading surface is rounded.

6. The improved blade of claim 1 wherein the leading surface is elliptical.

7. The improved blade of claim 1 wherein the leading surface is pointed.

8. An improved wind turbine comprising: at least one improved blade, at least one arm, at least one mast, and at least one spindle; the improved blade is connected with the arm, the arm is connected with the spindle, the spindle is connected with the mast.

9. The improved wind turbine of claim 8 further comprising a generator.

10. The improved wind turbine of claim 8 wherein the improved blade is comprised of a fiber-reinforced resin composite structure.

11. The improved wind turbine of claim 8 wherein the improved blade is comprised of carbon fiber.

12. The improved wind turbine of claim 8 wherein the improved blade has a leading surface which is rounded.

13. The improved wind turbine of claim 8 wherein the improved blade has a leading surface which is elliptical.

14. The improved wind turbine of claim 8 wherein the improved blade has a leading surface which is pointed.

15. An improved Darrieus-type wind turbine comprising at least one improved blade, one pole, and an apparatus for storing electricity.

16. The improved Darrieus type wind turbine of claim 15 wherein the improved blade is comprised of carbon fiber.

17. The improved Darrieus type wind turbine of claim 16 wherein the improved blade is comprised of a fiber-reinforced resin composite structure.

18. The improved Darrieus type wind turbine of claim 16 wherein the improved blade has a leading surface which is rounded.

19. The improved Darrieus type wind turbine of claim 16 wherein the improved blade has a leading surface which is elliptical.

20. The improved Darrieus type wind turbine of claim 16 wherein the improved blade has a leading surface which is pointed.
